(19) United States
(12) Patent Application Publication
(10) Pub. No.: US 2022/0269579 A1
(43) Pub. Date: Aug. 25, 2022

(54) PERFORMANCE METRIC MONITORING AND FEEDBACK SYSTEM

(71) Applicant: Capital One Services, LLC, McLean, VA (US)

(72) Inventors: AARON L. HOENIG, Plano, TX (US); Kumar ANAND, Plano, TX (US); Amit PANDEY, Plano, TX (US)

(73) Assignee: Capital One Services, LLC, McLean, VA (US)

(21) Appl. No.: 17/185,465

(22) Filed: Feb. 25, 2021

(51) Int. Cl. G06F 11/36

(52) U.S. Cl. CPC G06F 11/3616; G06F 11/3664; G06F 11/3612

(57) ABSTRACT

Disclosed herein are various embodiments for a performance metric monitoring and feedback system. An embodiment operates by determining a first performance metric for a first application available to a plurality of users of the first application operating first user devices. A second performance metric for a second application available to a plurality of users of the second application operating second user devices is determined. A real-time performance of both the first application and the second application is monitored across the set of computing devices. A user interface that simultaneously displays both the first performance metric for the first application and the second performance metric for the second application accessible to one or more members of the organization in accordance with the display format of the metric template is generated.

### BACKGROUND

When an organization is offering computing services to customers or to run its own business, it is often important to be able to monitor the health of the computing systems providing these services. Without easy and reliable health monitoring of the various computing and/or software systems, an organization would have to wait until a failure occurs to detect and resolve a problem with a computing system. When systems fail, there is often a cost to the organization in both lost revenue and lost productivity. As such, waiting until a failure occurs is often more expensive and time consuming than addressing and fixing the issue prior to the failure.

### BRIEF DESCRIPTION OF THE DRAWINGS

The accompanying drawings are incorporated herein and form a part of the specification.

FIG. 1 is a block diagram illustrating example functionality for providing a performance metric system (PMS), according to some embodiments.

FIG. 2A is a block diagram of an example user interface of a performance metric system, according to some example embodiments.

FIG. 2B is a block diagram of another example user interface of a performance metric system, according to some example embodiments.

FIG. 3 is a flowchart illustrating example operations for providing a performance metric monitoring and feedback system, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a performance metric monitoring and feedback system.

The ability to monitor the health or performance of computing or software systems, especially in a distributed environment can enable an organization to identify or even prevent system failures. For example, users may be notified when the performance of an application has fallen below a threshold. Users, such as developers or engineers may then address the problem before a failure occurs. However, monitoring these systems can be difficult or complex, especially when the systems are distributed in nature.

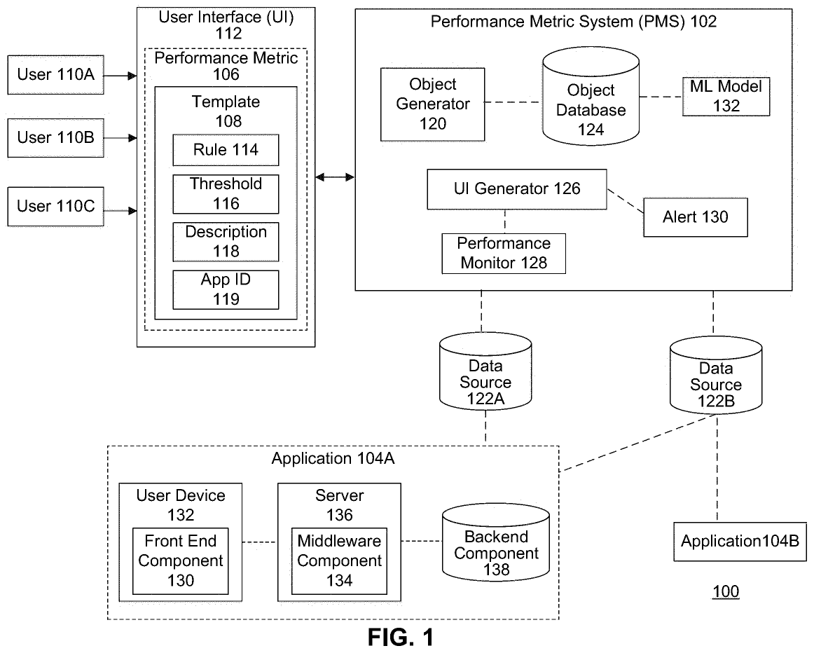

FIG. 1 is a block diagram 100 illustrating example functionality for providing a performance metric system (PMS) 102, according to some embodiments. PMS 102 may monitor the performance of applications 104A, 104B based on one or more performance metrics provided by users 110A-110C, aggregate that information from distributed application components, and provide it on a single user interface 112. The user interface 112 may provide for real-time monitoring of one or more user-defined performance metrics 106 against the applications 104A, 104B and may provide alerts 130 when any metric 106 falls below a threshold 116.

In an embodiment, applications 104A, 104B may be distributed applications that include different functionality or various components of a single application that are operating from different devices or servers. For example, application 104A may include a front end component 130 operating on a user device 132, in addition to a back end component 138 operating on a server device 136. User device 132 may be a mobile phone, tablet, laptop, or other computing device.

The front end component 130 may be communicatively coupled over a network to middleware component 134 operating from a server 136 that receives any user requests and provides responses to the user requests to the user interface or front end component 130. In an embodiment, the middleware component 134 or server 136 may be further communicative with one or more additional processing and/or data storage or backend components 138. Backend component 138 may actually perform the requested functionality and/or store or make available data of application 104A. In another embodiment, application 104A may also receive data from a different, non-monitored data source.

In an embodiment, PMS 102 may monitor each of the components and/or each of the devices that are executing the various components of the application 104A. The performance metrics 106 for these components and devices may then be provided together on a single user interface 112. In an embodiment, application 104B may also be distributed (e.g., in a similar or different fashion as shown for application 104A), but for simplicity, application 104B is illustrated as a single software component operating on one or more computing devices.

Through user interface (UI) 112, PMS 102 may alert users 110A-C when a problem is detected with one or more of applications 104A, 104B. This may enable users 110A-C to address and resolve the problem prior to it worsening or causing a system failure. In an embodiment, PMS 102 may provide visual indications of when a performance metric 106 is not being satisfied and may provide alerts 130 via UI 112 or over electronic communications directly to users 110A-C.

In an embodiment, user 110A may login to PMS 102 through UI 112. PMS 102 may request or receive a performance metric 106 from user 110A through UI 112. A performance metric 106 may be a technical or business based measure of success or failure of an application or computing system. A technical performance metric 106 may differentiate between a desired or undesirable performance of a computing device or system, such as system availability. A business based performance metric 106 may between a desired or undesirable performance with regard to some business activity, such as responding to customer inquiries or requests.

In an embodiment, PMS 102 may capture performance metrics 106 using a template 108. Template 108 may be a data structure associated with assembling or receiving the information that defines the performance metric 106. As used herein, performance metric 106 and template 108 may be used interchangeably.

In an embodiment, template 108 may include different pieces of information, such as a rule 114, threshold 116, and a description 118. Rule 114 may indicate what information or data is monitored by PMS 102, threshold 116 may indicate a benchmark or other value corresponding to the information or data being monitored, and description 118 may be text that describes the performance metric 106 and is displayed in UI 112. In an embodiment, template 108 may also include an application identifier (e.g., app ID) 119 that indicates to which application(s) 104A, 104B, application components (e.g., 130, 134, 138) and/or computing device(s) the particular performance metric 106 corresponds.

For example, template 108 for a technical performance metric 106 may indicate that application 104A should be available to a customer 99.9% of the time. The rule 114 may be that application 104A is available to a customer. The threshold 116 may be 99.9%. The description 118 may be “Availability” or any other user descriptor, such as “99.9% availability”. App ID 119 may be a name, title, or other identifier of application 104A. Users 110B and 110C may similarly enter their own performance metrics 106 into templates 108 for one or both of applications 104A, 104B.

An example business performance metric 106 may indicate that a customer receives a response to a loan application within 2 hours 95% of the time. The rule may be the loan response time less than or equal to two hours and the threshold 116 may be 95%. The description 118 may be whatever a user 110A-C inputs to describe the metric 106, such as “Loan Response Time”. The app ID 119 may indicate the name of a department, individual, or software system that is responsible for providing the loan response.

An object generator 120 may receive the input template 108 (including rule 114, threshold 116, description 118, and app ID 119) and generate a performance object that is stored in an object database 124.

In an embodiment, object generator 120 may be a serverless or stateless function operable on a cloud platform. This may enable PMS 102 to simultaneously receive and process performance metrics 106 and build performance objects from many different users 110A-C without requiring dedicated servers. As an example, object generator 120 may operate on Amazon Web Services (AWS) Lambda, which is both stateless and easily scalable. The generated performance objects may be stored in an object database 124.

In an embodiment, template 108 may indicate from which data source 122A, 122B to receive or monitor performance data or information. In an embodiment, data may be received from both data sources 122A and 122B. Data sources 122A, 122B may be any data structure or stream of data, including but not limited to a database. Template 108 may indicate which data corresponds to a performance of application 104A, 104B. Example data sources 122A, 122B may include, for example, a time series database, distributed tracing metrics from a plurality of sources, transaction logs, and/or data logs.

In an embodiment, data sources 122A, 122B may store business and/or computing events that are detected or that occur across one or more periods of time. For example, the performance data from data sources 122A, 122B may be grouped by hourly, daily, weekly, monthly, and/or yearly data, or other time periods. In an embodiment, data sources 122A, 122B may include information that was output directly from applications 104A, 104B as determined by PMS 102 or one or more other systems configured to track application performance.

In an embodiment, a performance monitor 128 may read or receive data from data sources 122A, 122B and compare the data to the performance objects stored in object database 124. Based on this comparison, performance monitor 128 may determine whether the particular metric is above, below, or within the expected or desired range indicated by template 108. This range or performance determination from performance monitor 128 may be provided to UI generator 126 which may display the information in a user interface 112 that enables users 110A-C to track or monitor the performance of applications 104A, 104B.

In an embodiment, PMS 102 may generate an alert 130 when performance monitor 128 determines that the performance of an application 104A, 104B falls below a threshold 116. The alert 130 may be a visual change in appearance in UI 112, auditory signal, or other electronic communication (e.g., text, phone call, email) to one or more users 110A-C responsible for handling the alert 130. In an embodiment, template 108 may include a user definable alert 130.

In an embodiment, template 108 may include multiple alerts 130, each with their own threshold 116 for the same performance data. For example, a first threshold 116 may indicate a first alert 130 providing a change in a visual appearance of a performance metric 106 in the UI 112. A second threshold 116 may correspond to a second alert 130 that involves the system notifying an engineer or other person via electronic communication (e.g., automated phone call, text, email, etc.). In an embodiment, the first time threshold 116 may indicate a value for a metric 106 that is below the value threshold 116 for a first period of time (e.g., 2 minutes), while the second time threshold 116 may indicate a value for the metric 106 that has remained below the value threshold 116 a second, longer period of time (e.g., 5 minutes). Or for example, if a desired performance is 90%, the first threshold may be violated when a performance value falls down to 92%, and the second threshold may be violated when the performance value falls to 90% or below.

In an embodiment, PMS 102 may use machine learning (ML) to build and execute an ML model 132 on the various performance objects of object database 124. The ML model 132 may use performance monitor 128 to track the performance of multiple applications across an organization or shared system of computing devices across various time periods. This functionality may enable PMS 102 to detect issues, problems, patterns, or failures that are shared across different applications 104A, 104B, that may otherwise go undetected.

For example, a company may release two different applications 104A, 104B operating on different servers. PMS 102 may generate UI 112 to enable users 110A-C to monitor each application 104A, 104B based on the uniquely defined templates 108 for the applications 104A, 104B. Meanwhile, ML model 132 may be used to determine any patterns in performance between the applications 104A, 104B. For example, ML model 132 may determine that there may be a relationship between performance metric A of application 104A and performance metric B of application 104B, because they move in a corresponding fashion (e.g., both rise or fall at around the same times).

ML model 132 may track the variances of the performances of the servers and both applications 104A, 104B and may identify patterns of failures or degradations in performance which may be related (e.g., that occur at or around the same time). The ML model 132 may then send an alert 130 to user 110A-C or developer who may be responsible for addressing the issues.

As indicated above, template 108 may include a description 118 that is displayed on the user interface 112. The description may be an alphanumeric description of the performance metric 106. In an embodiment, template 108 may also include other display formatting information. For example, template 108 may include font type, font size, color, formatting (e.g., underline, italics, bold), or even graphics or images to be displayed.

In an embodiment, an alert 130 may be customized such that a chosen graphic is displayed when particular values are reached. For example, if a performance falls below a threshold 116, an image of a flashing red stop sign may be displayed in the UI. Each template 108 may have its own unique display formatting formation. PMS 102 may then combine these all into a single UI 112 for users 110A-C. In an embodiment, users 110A-C may also define the order in which they want the template data displayed in the UI 112.

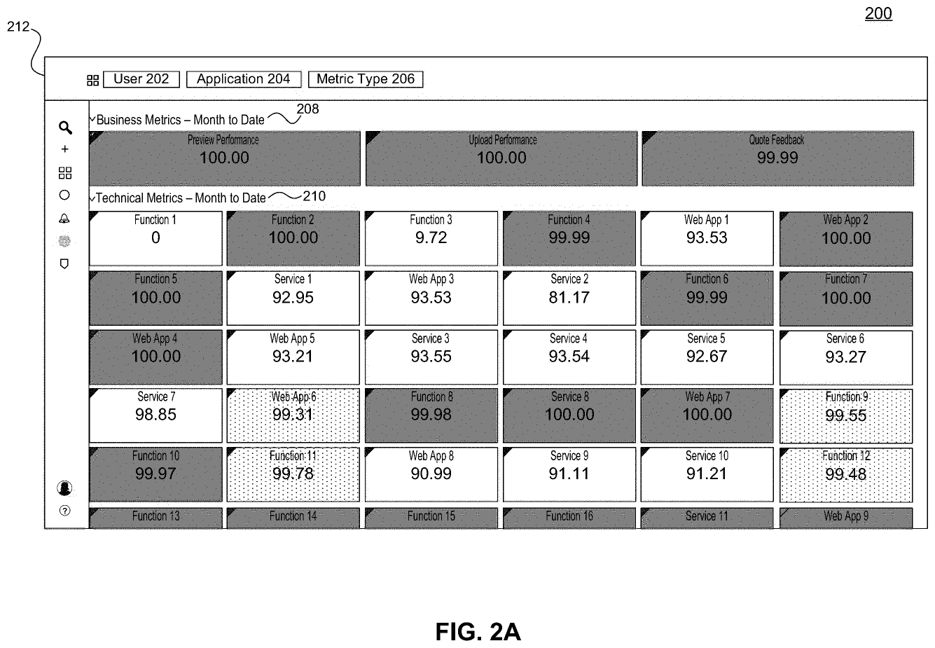

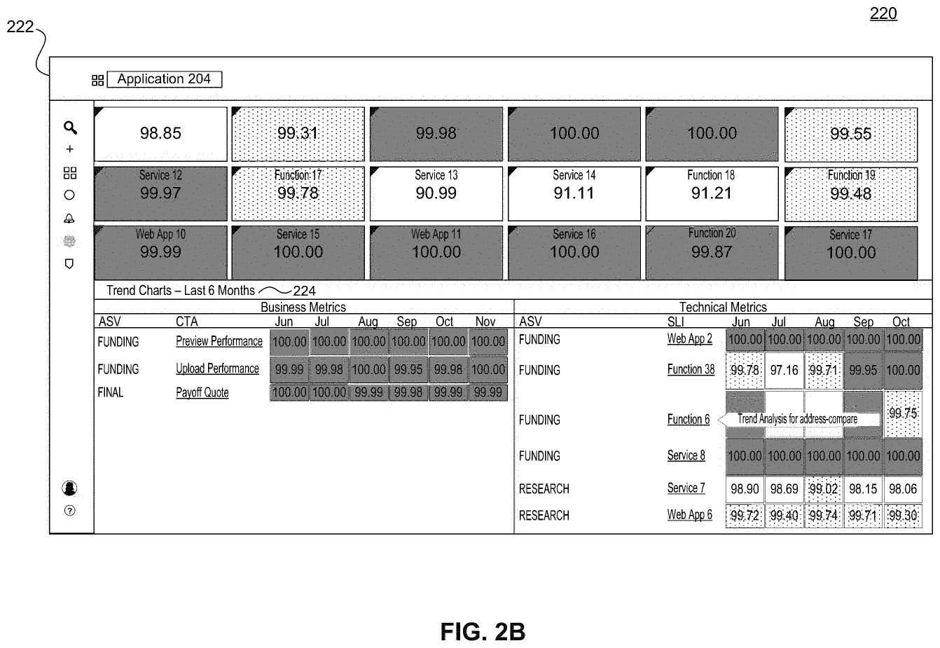

FIG. 2A is a block diagram 200 of an example user interface 212 of a performance metric system 102, according to some example embodiments. The illustrated user interface 212 (e.g., which may be an example embodiment of UI 112 of FIG. 1) may include both a business metrics 208 and technical metrics 210 section. The business metrics section 208 may include any business performance metrics 106 that have been created for a particular application, while the technical metrics section 210 includes any technical performance metrics 106 that have been created.

As illustrated the metrics 208 and 210 may represent the status or responsiveness of various functions 1-20, services 1-17, and/or web apps 1-11. The functions, services, and web apps are not intended to be limiting, but are just example embodiments, of programs and/or functionality that may be tracked by PMS 102 and/or viewed in a user interface. In an embodiment, the functions may be functions of the same or different programs, and may operate serially or in parallel.

In an embodiment, each of the elements of the user interface 212 may be independently configured for display with regard to value, threshold, labels, display or visual characteristics, and size. In an embodiment, the various statuses of the performance metrics 106 may be displayed both numerically with a numerical value (e.g., as retrieved from a data source 122A, 122B) and by a color, shading, or graphic that may indicate whether the respective performance metric 106 is being satisfied, is close to not being satisfied, or is failing in accordance with a particular metric 106. In an embodiment, PMS 102 may aggregate the information for the various components and devices of applications 104A, 104B for the various performance metrics 106 and display them each with their own unique display characteristics or formatting in a single user interface 212.

Each displayed template 108 (e.g., business metrics 208 and technical metrics 210) may have its own unique size and location which may be specified within the display format options of template 108. For simplicity sake, the business metrics 208 are illustrated as one size, while the technical metrics 210 are illustrated as being of a different size.

In an embodiment, the user interface 212 may be sorted and/or filtered based on user 202, application 204, and metric type 206. For example, the user 202 option may display those metrics that were created by and/or that a particular user who is logged into the system is responsible for monitoring and/or resolving. The application 204 option may allow for a selection of one or more applications 104A, 104B for which the performances are being displayed. The metric type 206 option may enable a user to select between business metrics 208, technical metrics 210, or both. In an embodiment, user interface 212 may also be filtered to only show those metrics for which alerts 130 are or have been issued (e.g., that are not satisfying their particular threshold 116).

In an embodiment, the user interface 212 may also be configurable over a period of times. For example, the metrics shown may be “Month to Date” metrics, but in other embodiments, the metrics displayed may be daily metrics, weekly metrics, year to date metrics, or metrics over any period of time which the user selects.

FIG. 2B is a block diagram 220 of another example user interface 222 of a performance metric system 102, according to some example embodiments. User interface 222 may be similar to user interface 212 in that various metrics are illustrated with their own respective numerical and visual appearance encoding based on performance. User interface 222 may be another example embodiment of UI 112 of FIG. 1.

In an embodiment, user interface 222 may be a different portion of user interface 212.

For example, user interface 222 may be a different portion of the user interface 212 which the user could have scrolled to access. Or, for example, a user may have selected different view or filter options from user interface 212 to view user interface 2222.

In an embodiment, user interface 222 may include a trend chart section 224 in which a user may select various business and/or technical indicators and view their historical performance over a specific period of time (which may be different from the period of time of the other displayed scores). For example, in an embodiment, PMS 102 may track, record, or store the performance of application 104A, 104B over time in accordance with performance metrics 106. For example, PMS 102 may record when and for how long thresholds 116 for various performance metrics 106 were exceeded or not exceeded. This information may be stored in object database 124, data source 122A, data source 122B, or another storage location. In an embodiment, user interface 222 may enable a user to compare different metrics 106 for different applications 104A, 104B over different or overlapping periods of time.

In the example illustrated in user interface 222, the top three rows of scores may be month-to-date scores or performances of an application 204 for each indicated month. A user may select one or more of those scores and evaluate the present score to the historical scores over the past 6 months to view any variances and determine if there may be a problem.

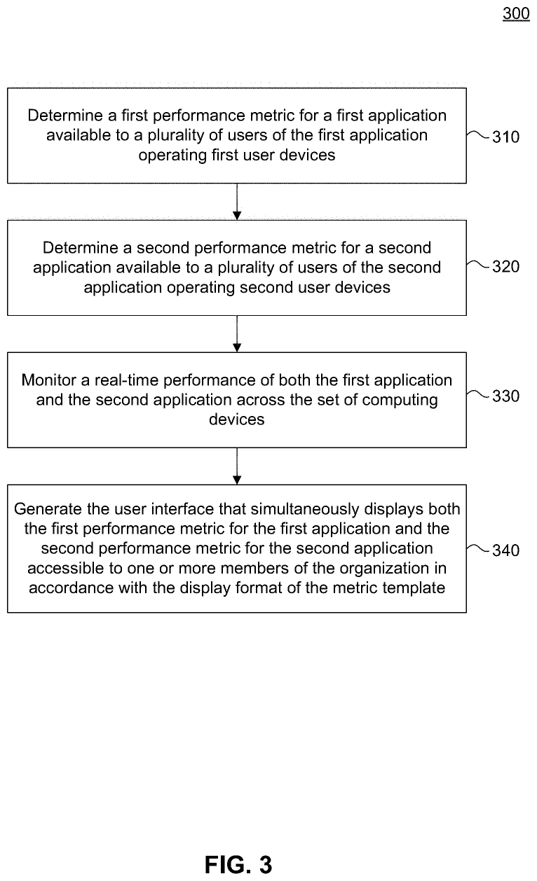

FIG. 3 is a flowchart 300 illustrating example operations for providing a performance metric monitoring and feedback system, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Without limiting method 300, method 300 is described with reference to elements in FIG. 1.

At 310, a first performance metric for a first application available to a plurality of users of the first application operating first user devices is determined. For example, user 110A may enter a rule 114, threshold 116, description 118, and app ID 119 for a performance metric 106 in accordance with template 108. The template 108 may also include additional display format characteristics selectable and/or configurable by user 110A.

At 320, a second performance metric for a second application available to a plurality of users of the second application operating second user devices is determined. For example, user 110B may enter a rule 114, threshold 116, description 118, app ID 119, and any display format characteristics in accordance with template 108. In an embodiment, a template 108 for a business metric may vary from a template for a technical or computing metric.

A received performance metric 106 may correspond to one of application 104A or 104B, which may be applications 104A, 104B that are provided or used by the same organization. In an embodiment, the organization may license computing space or bandwidth from a cloud services provider that makes the applications 104A, 104B available to customers of the organization. Users 104A-C of the organization may then monitor the performance of the applications 104A, 104B, as they are hosted by the cloud services provider. In another embodiment, the organization may have its own computing devices or servers that are used to host the applications 104A, 104B.

At 330, a real-time performance of both the first application and the second application across the set of computing devices is monitored. For example, PMS 102 may receive and monitor data from data source 122A and/or data source 122B and compare the data to the rule 114 and threshold 116 information across one or more performance metrics 106.

At 340, the user interface is generated, the user interface simultaneously displaying both the first performance metric for the first application and the second performance metric for the second application accessible to one or more members of the organization in accordance with the display format of the metric template. For example, a UI generator 126 may generate a user interface 112 (e.g., 212 and 222) that displays the performance metrics across the applications 104A, 104B. From UI 112, a user may visually be able to determine based on text, color scheme, and/or numerical values which performance metrics 106 are being satisfied and which are not.

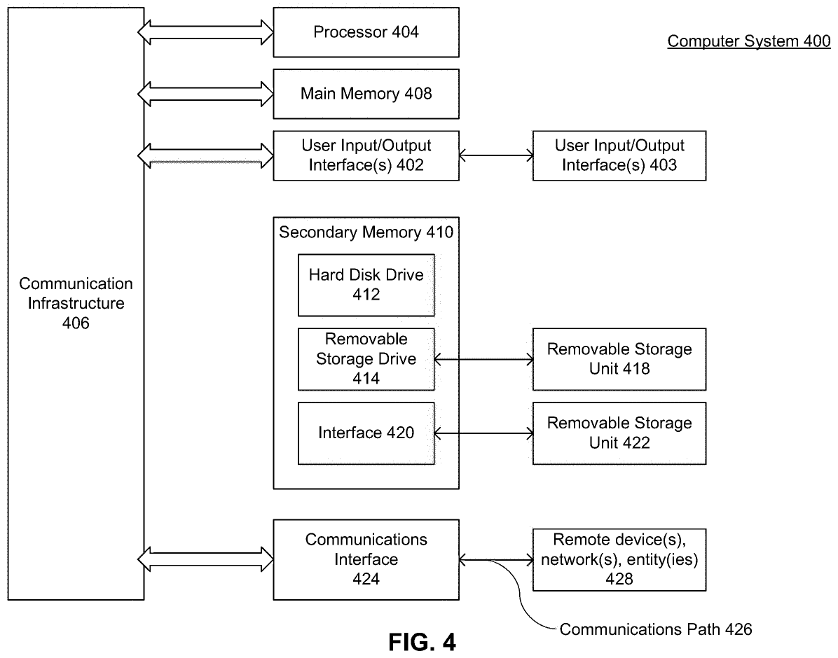

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include customer input/output device(s) 403, such as monitors, keyboards, pointing devices, etc., which may communicate with communication infrastructure 406 through customer input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer usable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method, comprising:
determining a first performance metric for a first application available to a plurality of users of the first application operating first user devices, wherein the first performance metric is organized in accordance with a metric template, the metric template comprising fields for an application identifier, a rule, a threshold and a description, wherein the metric template includes a display format indicating one or more font display characteristics and one or more alert display characteristics indicating that the first performance metric is falling below the threshold for generating a user interface;
determining a second performance metric for a second application available to a plurality of users of the second application operating second user devices, wherein the second performance metric is organized in accordance with the metric template, wherein both the first performance metric and the second performance metric each comprises its own rule, threshold, and description for a desired performance of either the first application or the second application in accordance with the metric template, wherein the first performance metric and the second performance metric each comprises its own font display characteristics and alert display characteristics in its metric template, wherein a first value of a first font display characteristic of the one or more font display characteristics of the first performance metric is different from a second value of first font display characteristic of the second performance metric, wherein both the first application and the second application are hosted on a set of computing devices that are allocated to an organization associated with both the first application and the second application, and wherein the set of computing devices receive and respond to requests from the first user devices and the second user devices;
monitoring a real-time performance of both the first application and the second application across the set of computing devices; and
generating the user interface simultaneously displaying both the first performance metric for the first application and the second performance metric for the second application accessible to one or more members of the organization in accordance with the one or more font display characteristics of the display format of the metric template, wherein the user interface visually indicates whether each displayed performance metric is being satisfied by the set of computing devices hosting the first application and the second application based on the monitoring.

2. The method of claim 1, further comprising:
receiving the rule, threshold and description for the first performance metric from a first user via a first instance of an input interface, and wherein the generated user interface displays the description received from the first user.

3. The method of claim 2, further comprising:
receiving the rule, threshold and description for the second performance metric from a second user via a second instance of the input interface, and wherein the generated user interface displays the description received from the second user.

4. The method of claim 3, wherein the first performance metric corresponds to information retrievable from a first data source associated with the first application, and wherein the second performance metric corresponds to information retrievable from a second data source associated with the second application.

5. The method of claim 2, further comprising:
determining that the first performance metric is not being satisfied by the first application based on the monitoring; and
changing a visual appearance of the first performance metric on the generated user interface to indicate that the application has not satisfied the first performance metric.

6. The method of claim 1, wherein the first application comprises a first component and a second component that are communicatively coupled to provide a function of the first application, wherein the first component provides a first functionality operating from a first device, and wherein the second component provides a second functionality operating from a second device.

7. The method of claim 6, further comprising:
determining a third performance metric corresponding to the first component operating from the first device, and a fourth performance metric corresponding to the second component operating from the second device, and wherein the user interface visually indicates whether each the third performance metric and the fourth performance metric are being satisfied.

8. A system for efficient utilization of cloud computing services, comprising:
a memory; and
at least one processor coupled to the memory and configured to perform operations comprising:
determining a first performance metric for a first application available to a plurality of users of the first application operating first user devices, wherein the first performance metric is organized in accordance with a metric template, the metric template comprising fields for an application identifier, a rule, a threshold and a description, wherein the metric template includes a display format indicating one or more font display characteristics and one or more alert display characteristics indicating that the first performance metric is falling below the threshold for generating a user interface;
determining a second performance metric for a second application available to a plurality of users of the second application operating second user devices, wherein the second performance metric is organized in accordance with the metric template, wherein both the first performance metric and the second performance metric each comprises its own rule, threshold, and description for a desired performance of either the first application or the second application in accordance with the metric template, wherein the first performance metric and the second performance metric each comprises its own font display characteristics and alert display characteristics in its metric template, wherein a first value of a first font display characteristic of the one or more font display characteristics of the first performance metric is different from a second value of first font display characteristic of the second performance metric, wherein both the first application and the second application are hosted on a set of computing devices that are allocated to an organization associated with both the first application and the second application, and wherein the set of computing devices receive and respond to requests from the first user devices and the second user devices;
monitoring a real-time performance of both the first application and the second application across the set of computing devices; and
generating the user interface simultaneously displaying both the first performance metric for the first application and the second performance metric for the second application accessible to one or more members of the organization in accordance with the one or more font display characteristics of the display format of the metric template, wherein the user interface visually indicates whether each displayed performance metric is being satisfied by the set of computing devices hosting the first application and the second application based on the monitoring.

9. The system of claim 8, wherein the operations further comprise:
receiving the rule, threshold and description for the first performance metric from a first user via a first instance of an input interface, and wherein the generated user interface displays the description received from the first user.

10. The system of claim 9, wherein the operations further comprise
receiving the rule, threshold and description for the second performance metric from a second user via a second instance of the input interface, and wherein the generated user interface displays the description received from the second user.

11. The system of claim 10, wherein the first performance metric corresponds to information retrievable from a first data source, and wherein the second performance metric corresponds to information retrievable from a second data source.

12. The system of claim 8, wherein the operations further comprise:
determining that the first performance metric is not being satisfied by the first application based on the monitoring; and
changing a visual appearance of the first performance metric on the generated user interface to indicate that the application has not satisfied the first performance metric.

13. The system of claim 8, wherein the first application comprises a first component and a second component that are communicatively coupled to provide a function of the first application, wherein the first component provides a first functionality operating from a first device, and wherein the second component provides a second functionality operating from a second device.

14. The system of claim 13, wherein the operations further comprise:
determining a third performance metric corresponding to the first component operating from the first device, and a fourth performance metric corresponding to the second component operating from the second device, and wherein the user interface visually indicates whether each the third performance metric and the fourth performance metric are being satisfied.

15. A non-transitory computer-readable device having instructions stored thereon that, when executed by at least one computing device, cause the at least one computing device to perform operations for efficient utilization of cloud computing services, the operations comprising:
determining a first performance metric for a first application available to a plurality of users of the first application operating first user devices, wherein the first performance metric is organized in accordance with a metric template, the metric template comprising fields for an application identifier, a rule, a threshold and a description, wherein the metric template includes a display format indicating one or more font display characteristics and one or more alert display characteristics indicating that the first performance metric falling below the threshold for generating a user interface;
determining a second performance metric for a second application available to a plurality of users of the second application operating second user devices, wherein the second performance metric is organized in accordance with the metric template, wherein both the first performance metric and the second performance metric each comprises its own rule, threshold, and description for a desired performance of either the first application or the second application in accordance with the metric template, wherein the first performance metric and the second performance metric each comprises its own font display characteristics and alert display characteristics in its metric template, wherein a first value of a first font display characteristic of the one or more font display characteristics of the first performance metric is different from a second value of first font display characteristic of the second performance metric, wherein both the first application and the second application are hosted on a set of computing devices that are allocated to an organization associated with both the first application and the second application, and wherein the set of computing devices receive and respond to requests from the first user devices and the second user devices;
monitoring a real-time performance of both the first application and the second application across the set of computing devices; and
generating the user interface simultaneously displaying both the first performance metric for the first application and the second performance metric for the second application accessible to one or more members of the organization in accordance with the one or more font display characteristics of the display format of the metric template, wherein the user interface visually indicates whether each displayed performance metric is being satisfied by the set of computing devices hosting the first application and the second application based on the monitoring.

16. The device of claim 15, wherein the operations further comprise:
receiving the rule, threshold and description for the first performance metric from a first user via a first instance of an input interface, and wherein the generated user interface displays the description received from the first user.

17. The device of claim 16, wherein the operations further comprise
receiving the rule, threshold and description for the second performance metric from a second user via a second instance of the input interface, and wherein the generated user interface displays the description received from the second user.

18. The device of claim 17, wherein the first performance metric corresponds to information retrievable from a first data source, and wherein the second performance metric corresponds to information retrievable from a second data source.

19. (canceled)

20. (canceled)

21. The method of claim 1, wherein the second performance metric is below its threshold and the alert display characteristics are generated on the user interface for both the first performance metric and the second performance metric being below their respective thresholds.

22. The method of claim 1, wherein the monitoring comprises:
determining that there is a correspondence between the first performance metric of the first application and the second performance metric of the second application based on a machine learning model performing the monitoring.
